(19) United States
(12) Patent Application Publication
(10) Pub. No.: US 2002/0000128 A1
(43) Pub. Date: Jan. 3, 2002

(54) FRACTURE DETECTION COATING SYSTEM

(76) Inventor: MARK D. WILLIAMS, SALT LAKE CITY, UT (US)

Correspondence Address: Jones, Waldo, Holbrook & McDonough, 170 South Main Street, Suite 1500, Salt Lake City, UT, 84101-1644, US

(21) Appl. No.: 09/418,800

(22) Filed: Oct. 15, 1999

(51) Int. Cl. G01N 29/04; B05D 1/00

(52) U.S. Cl. 73/762; 73/799; 73/104; 427/8

(57) ABSTRACT

A method for monitoring a structure (10) for the formation of cracks (18) includes first pretreating a surface (14) of the structure by applying a first coating (30) to the structure which bonds uniformly to the surface of the structure and creates a uniform surface coat. A second coating (40) is applied over the first coating and contains microcapsules (44). The microcapsules rupture in response to cracking of the structure to release a dye or pigment which changes the color of the second coating about the crack. Cracked portions which form in the structure may then be identified by observing color changes (48) in the second coating resulting from eruption of the microcapsules.

### BACKGROUND OF THE INVENTION

1. The Field of the Invention

The present invention relates generally to a method of detecting cracks in structures, such as concrete columns, dams, building structures, bridges, pipes, retaining walls, vessels, aircraft, and the like. More particularly, the present invention relates to a method in which a second coating, including microcapsules which rupture under stress, is applied over a first binder coating which provides a substantially uniform surface coat for the second coating.

2. The Background Art

A large portion of the highway infrastructure is in need of repair. Studies indicate that nearly a quarter of the half million highway bridges in the United States have been classified as structurally deficient. Each year, on average, between 150 and 200 spans suffer partial or complete collapse. Current estimates for repairing deficient bridges are on the order of $100 billion.

The potentially catastrophic consequences of fatigue cracking can be avoided by the early detection of fatigue cracks, for example, typically found in pre-stressed concrete. Additionally, early detection of cracks can significantly reduce the cost of repairs.

A national mandate requires that bridges be inspected at least every two years. The most frequently used method of inspecting bridge components, like pre-stressed concrete, for fatigue damage has been the elementary method of visual inspection. In order for the inspection to be of any value, the inspectors must find flaws early, and accurately judge which ones need immediate repair and which ones can wait. Although an inspector will typically examine the entire structure, a high percentage of cracks occur in common or critical locations. The most revealing sign of a crack is the existence of rust, oxide film and powder. However, since rust does not always appear immediately after a crack is formed, cracks may go undetected during visual inspection.

Once a crack is observed or suspected, the structure is further tested to determine the extent or severity of the damage. A number of techniques are currently used to confirm the existence of a crack. One well-known technique is the application of a dye penetrant to the crack in question. A liquid penetrant is applied evenly over the surface being tested and allowed to enter open discontinuities. The excess surface penetrant is removed by wiping, and the surface is dried. A developer is then applied, drawing the penetrant out of the discontinuity, staining the developer.

Another widely used technique is magnetic particle testing. This test method is used to detect cracks in steel by applying a magnetic field through the surface with a permanent or electromagnet. The specimen is then sprayed with an ink containing the magnetic dust. The difference in flux density at a crack causes the particles to be attracted to the crack, which makes the crack visible.

Another method, ultrasonic testing, involves the transmission of ultrasonic pulses by piezoelectric transducers through a material. Changes in the amplitude of the received signal indicates the presence of a crack or flaw.

Still another technique, eddy current imaging, measures changes in electrical impedance produced in a material by an induction coil. A flaw changes the detectable current.

Acoustic emission testing involves the monitoring of transient waves resulting from energy releases due to crack growth.

X-ray and penetrating radiation methods are also used for flaw detection in materials.

Brittle lacquer coatings have long been recognized as a means for evidencing the existence of strain in a material. These coatings crack in response to the substrate. In order to be of quantitative value, the coating must be used in a controlled environment and applied in a precise and uniform manner. The lacquer coatings are also limited to work that can be closely observed so that the cracks in the lacquer can be seen. These brittle coatings are of little use for corrosion protection.

Photoelastic coatings are another known crack detection technique. Photoelastic materials, when subject to a stress or strain field, exhibit bifringence, which is seen as a fringe pattern when viewed through a polariscope.

The aforementioned prior art detection techniques require the initial step of observation of a crack by a trained inspector. Additionally, many of these techniques require complex machinery, and/or cumbersome and expensive physical removal of the structural member in question in order to confirm the existence of, or evaluate the extent of, the crack.

Visual inspection of bridge components on site, and at susceptible locations of the structure, remains the first line of action. Thus, there is a current need to improve an inspector's ability to detect cracks during an initial visual inspection. Early detection will result in savings of time and money. Making inspections more accurate will reduce the number of inspections needed, and will minimize repair costs.

One example of a method for monitoring the formation of cracks is disclosed in U.S. Pat. No. 5,534,289, issued Jul. 9, 1996, to Bilder et al., which is herein incorporated by reference. Bilder et al. discloses applying a first coating with microcapsules of a first color to the structure, and then applying a second coating of a second color over the first coating. The microcapsules rupture in response to cracking of the structure, and change the second color of the second coating.

One disadvantage with this type of system is that the dye in the microcapsules must leak not only through the first layer containing the microcapsules, but also through the second layer covering the first layer. Thus, the change in color of the second layer may be more difficult to detect, or detection may be delayed. Another disadvantage is that the color of the microcapsules must be different from the color of the second coating or the change in color may be indiscernible.

Another disadvantage is that the microcapsules in the first coating may rupture only if the first layer is sufficiently coating the structure. The materials of the structure and first coating, however, may inhibit the sufficiency of the coating. In addition, the surface of the structure may have surface irregularities which may effect how the first coating coats the surface.

Microcapsule-based products are used in a variety of industries, including pharmaceutical, graphic art, pesticide, and food industries. For instance, in the pharmaceutical industry, microencapsulation provides an effective mechanism for controlled release drugs. The largest application for microcapsules in the production of carbonless copy paper.

Many processes for preparing microcapsules have been reported in the literature, including pan coating, centrifugation, biliquid column, electrostatic encapsulation, vapor deposition, solvent evaporation, and gelation.

The formation and structure of microcapsules is described in U.S. Pat. No. 4,253,877 to Miale et al., U.S. Pat. No. 4,067,840 to Wolf, and U.S. Pat. Nos. 4,000,345 and 4,089,834 to Powell, which are herein incorporated by reference.

Therefore, it would be advantageous to develop a method for detecting or monitoring structural cracks which is easily visible, and propagates quickly. It would also be advantageous to develop such a method which improves the bonding of the coating containing microcapsules to the structure. It would also be advantageous to develop such a method which accommodates irregular surfaces of the structure.

### OBJECTS AND SUMMARY OF THE INVENTION

It is therefore an object of the present invention to provide a method for detecting and/or monitoring cracks in structures.

It is another object of the present invention to provide such a method which more uniformly bonds to the surface of the structure.

It is another object of the present invention to provide such a method which uniformly treats the irregular surfaces of the structure.

The above objects and others not specifically recited are realized in a specific illustrative embodiment of a method for monitoring stress or fatigue cracks in structures. The method includes pre-treating a surface of the structure by applying a first binder coating to the structure. The first coating includes a binder which bonds substantially uniformly to the structure, and defines a substantially uniform surface coat which increases bonding of the second coat to the structure through the first layer.

A second coating is applied over the first coating. The second coating includes microcapsules configured for rupturing in response to cracking or stress in the structure and first coating. The microcapsules contain a dye or pigment which is released upon rupturing and penetrates or leaks through the second coating where it may be observed.

The cracked portions which form in the structure may be identified by observing changes in the color of the second coating itself resulting from eruption of the microcapsules.

The second coating has a first color, and the microcapsules contain a different second color. Because the dye or pigment must only leak through the second coating to be visible, the first and second coatings may be the same color.

In accordance with one aspect of the present invention, the weight of the microcapsules preferably is between approximately 4 to 96 percent of the weight of the second layer. Most preferably, the weight of the microcapsules is between approximately 20 to 25 percent of the weight of the second layer.

In accordance with another aspect of the present invention, a third coating may be applied over the second coating.

Additional objects and advantages of the invention will be set forth in the description which follows, and in part will be apparent from the description, or may be learned by the practice of the invention without undue experimentation. The objects and advantages of the invention may be realized and obtained by means of the instruments and combinations particularly pointed out in the appended claims.

### BRIEF DESCRIPTION OF THE DRAWINGS

The above and other objects, features and advantages of the invention will become apparent from a consideration of the subsequent detailed description presented in connection with the accompanying drawings in which:

FIG. 1 is a cross-sectional schematic view of coatings applied to a structure in accordance with a preferred embodiment of the present invention; and

FIG. 2 is a cross-sectional schematic view of coatings applied to a structure in accordance with an alternative embodiment of the present invention.

### DETAILED DESCRIPTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

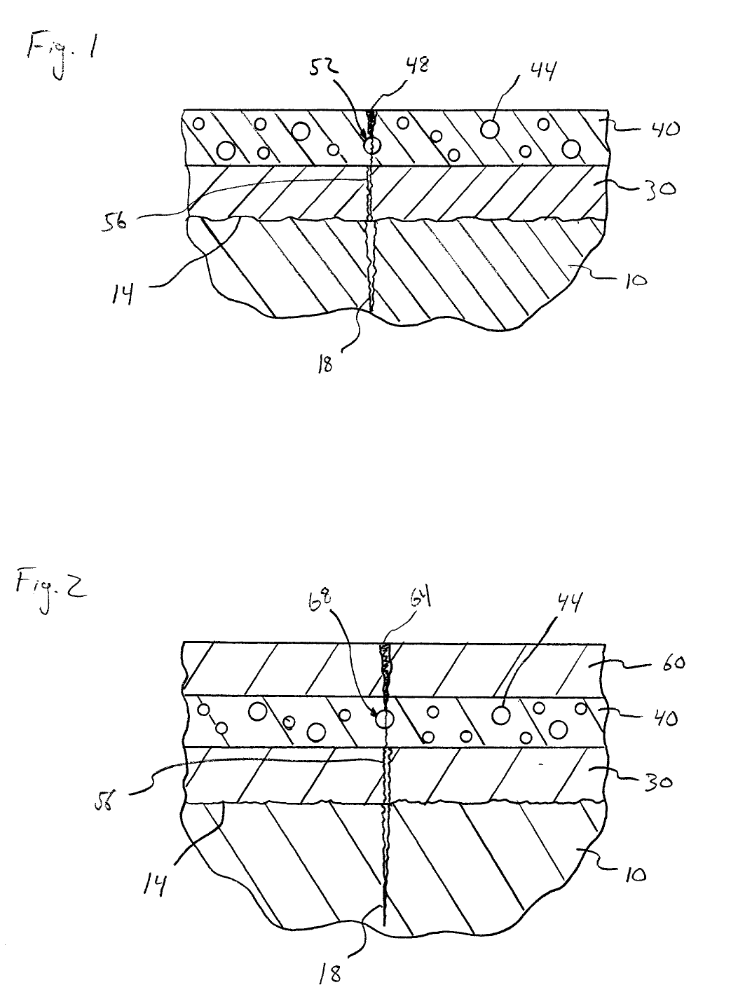

As illustrated in FIG. 1, a structure, indicated generally at 10, is shown coated in accordance with the method of the present invention. The structure 10 may be a pipe, column, dam, beam, vessel, bridge, aircraft, retaining wall, tank, concrete pad, or lock. In addition, the structure 10 may be formed of concrete, metal, composite, or the like. The structure 10 has a surface 14 which is coated. Although the surface 14 may appear to be generally smooth, the surface 14 of many structures may actually be irregular or rough, or have other non-uniform surface conditions. The irregularities may be indentations and/or protrusions left in the surface 14 during manufacturing or handling. In addition, the irregularities may be much smaller, such as microscopic, formed by irregularities in the material of the structure itself. Thus, the irregularities may range in size from microscopic to relatively macroscopic in the sense that they may be visible with the unaided eye. As discussed above, cracks are formed and/or stresses are experienced, represented at 18, by the structure 10.

The method of the present invention advantageously includes first pre-treating the surface 14 of the structure 10 to prepare the surface 14 and provide a more uniform surface. The surface 14 is treated by applying a first coating 30 to the surface 14 of the structure 10. The first coating 30 includes a binder which bonds substantially uniformly to the surface 14, and leaves a substantially uniform surface coat which increases the bonding of a second coating to the structure through the first coating 30, as discussed more fully below. The binder may include commonly used paint binder, including for example alkyd, epoxy, epoxy ester, epoxy lacquer, two component epoxy, epoxy-coal tar, waterborne epoxy, latex, rubber-base, chlorinated rubber, silicone (silicon resin, silicon alkyd), urethane (oil-modified urethane, moisture-cured urethane, two-component urethane, aromatic urethane, aliphatic urethane), and vinyl (PVB, polyvinyl chloride, polyvinyl acetate, vinyl-alkyd). The first coating 30 may be similar to a primer or sealer coating to better prepare the surface 14, and seal any irregularities or other surface conditions.

Next, a second coating 40 is applied over the first coating 30. The second coating 40 contains microcapsules 44. The microcapsules 44 contain a dye or pigment which may be any hue, including white, black and grey. The microcapsules 44 have a capsule wall which surrounds and contains the dye or pigment. The capsule walls, or microcapsules 44, have a sheer or breakage point at which the capsule wall ruptures. In addition, the second coating 40 may have a hardener which is balanced to the breakage point of the microcapsules 44 so that microcapsules are properly activated. The second coating 40 also may contain a binder which may be any commonly used paint binder as listed above. The binder may or may not include pigment. Opacity is not an issue because the dye color contained in the microcapsules must only be in contrast. For example, a light pigment coating preferably would use dark dyes in microcapsules 44.

Because of the substantially uniform surface coat formed by the first coating 30 and the bonding properties therein, the bond between the surface 14 of the structure 10 and the second coating 40, through the first coating 30, is advantageously improved and the performance of the second coating 30 is improved. It has been found that the first binder coating 30 causes the second coating 40, with the microcapsules 44, to perform more uniformly, and the microcapsules 44 will break with greater uniformity and dependability. Without the first binder coating 30, the second coating 40, with the microcapsules 44, does not perform with uniformity due to numerous surface conditions and numerous varieties of materials that will produce different performance. Use of the first binder coating 30 provides a uniform surface coat so that uniform performance is obtained.

It has been found that the preferable composition of the second coating 40 is with the weight of the microcapsules 44 being between approximately 4 to 96% of the weight of the second coating 40. The most preferable composition has been found to be with the weight of the microcapsules 44 being between approximately 20 to 25% of the weight of the second coating 40. The microcapsules 44 have a diameter of between approximately 1 to 1000 microns.

The second coating 40 may be a paint or the like with a first color, while the microcapsules have a different second color. Thus, a change in color may be observed in the second coating 40, as indicated at 48, when a microcapsule is ruptured, as indicated at 52. Because the dye or pigment of the microcapsule 52 only needs to penetrate or leak through the second coating 40, the first and second coatings 30 and 40 advantageously may be the same color.

As cracks 18 form in the structure 10, or as the structure 10 fractures or strains, the first coating 30 similarly cracks, indicated at 56, and microcapsules 52 erupt or rupture to release dye or pigment into the second coating 40. The dye or pigment from the ruptured microcapsules 52 leaks or penetrates through the second coating 40 to the surface of the second coating 40 where it may be more clearly observed. Thus, cracked portions which form in the structure 10 may be identified by observing the changes in color of the second coating 40.

Referring to FIG. 2, a third coating 60 may be applied over the second coating 40. The third coating 60 should have a third color, different from the color of the microcapsules 44, so that the change of color, indicated at 64, of the third coating 60 is observable when a microcapsule 68 ruptures. The third coating 60 may be any commercially available top-coating of any color that is acceptable for penetrating dye therethrough and which would be visible.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for monitoring a structure for the formation of cracks, comprising the steps of:
a) applying to the structure a first coating;
b) applying over the first coating, a second coating including microcapsules; and
c) identifying cracked portions, which form in the structure, by observing changes in color of the second coating resulting from eruption of the microcapsules.

2. The method of claim 1, wherein the first coating comprising a binder which bonds substantially uniformly to the structure defining a substantially uniform surface coat for increasing bonding of the second coating to the structure through the first coating.

3. The method of claim 1, wherein the second coating comprises a hardener which is balanced to about a breakage point of the microcapsules.

4. The method of claim 1, wherein the first and second coatings are the same color.

5. The method of claim 1, wherein the second coating has a first color, and the microcapsules contain a different second color.

6. The method of claim 1, wherein the weight of the microcapsules is between approximately 4 to 96 percent of the weight of the second layer.

7. The method of claim 1, wherein the weight of the microcapsules is preferably between approximately 20 to 25 percent of the weight of the second layer.

8. The method of claim 1, wherein step (b) further comprises applying a third coating over the second coating.

9. The method of claim 1, wherein the microcapsules have a diameter of between approximately 1 to 1000 microns.

10. A method for monitoring a structure for the formation of cracks, comprising the steps of:
a) pretreating a surface of the structure by applying a first binder coating to the structure; and
b) applying over the first coating, a second coating including microcapsules configured for rupturing in response to cracking or stress in the structure and first coating.

11. The method of claim 10, further comprising the step of identifying cracked portions which form in the structure by observing color changes in the second coating resulting from eruption of the microcapsules.

12. The method of claim 10, wherein the first coating comprising a binder which bonds substantially uniformly to the structure defining a substantially uniform surface coat for increasing bonding of the second coating to the structure through the first layer.

13. The method of claim 10, wherein the second coating comprises a hardener which is balanced to about a breakage point of the microcapsules.

14. The method of claim 10, wherein the first and second coatings are the same color.

15. The method of claim 10, wherein the second coating has a first color, and the microcapsules contain a different second color.

16. The method of claim 10, wherein the weight of the microcapsules preferably is between approximately 4 to 96 percent of the weight of the second layer.

17. The method of claim 10, wherein the weight of the microcapsules is between approximately 20 to 25 percent of the weight of the second layer.

18. The method of claim 10, further comprising the step of applying over the second coating, a third coating.

19. The method of claim 10, wherein the microcapsules have a diameter of between approximately 1 to 1000 microns.

20. A method for monitoring a structure for the formation of cracks, comprising the steps of:
a) applying to the structure a first coating including a binder to form a substantially uniform surface coating; and
b) applying over the first coating, a second coating comprising microcapsules, the microcapsules having a preferred weight which is between approximately 20 to 25 percent of the weight of the second coating.

21. The method of claim 20, further comprising the step of identifying cracked portions which form in the structure by observing changes in color of the second coating resulting from eruption of the microcapsules which contain a dye.

22. The method of claim 20, wherein the second coating comprises a hardener which is balanced to about a breakage point of the microcapsules.

23. The method of claim 20, wherein the first and second coatings are a same color.

24. The method of claim 20, wherein the second coating has a first color, and the microcapsules contain a different second color.

25. The method of claim 20, further comprising the step of applying over the second coating, a third coating.

26. The method of claim 20, wherein the microcapsules have a diameter of between approximately 1 to 1000 microns.
